(19) United States
(12) Patent Application Publication
(10) Pub. No.: US 2020/0212841 A1
(43) Pub. Date: Jul. 2, 2020

(54) AN IMPROVED CONCENTRATED SOLAR POWER APPARATUS ENABLED BY FRESNEL LENS TUNNEL

(71) Applicant: Rajesh Dhannalal Jain, Pune, Maharashtra (IN)

(72) Inventor: Rajesh Dhannalal Jain, Pune, Maharashtra (IN)

(21) Appl. No.: 16/639,123

(22) PCT Filed: Sep. 6, 2017
(86) PCT No.: PCT/IB2017/055352

§ 371 Date: Feb. 13, 2020

(30) Foreign Application Priority Data
Aug. 24, 2017 (IN) 201721030093

(51) Int. Cl. H02S 40/22; F24S 23/30; F24S 23/70; H02S 40/44; H02S 20/32

(52) U.S. Cl. CPC H02S 40/22; F24S 23/31; H02S 20/32; H02S 40/44; F24S 23/70

(57) ABSTRACT

A Concentrated Solar Power (CSP) apparatus to capture Direct Normal Irradiance (DNI) in form of thermal energy and to store the thermal energy in the form of a heat, in a plurality of Thermal Storage Material, to be used as a heat source is described, the apparatus comprising at least one Fresnel Lens Tunnel 12. A receiver 7 containing a re-circulating TES material is implemented. The apparatus may further comprise the FLT 12 comprising at least three non-imaging concentrating optical elements and at least one Enveloped Linear Fresnel Reflector 13 to power each side of the FLT 12 which is not receiving DNI and at least one Reflector and Lens Mount with Shield (RLMS 14), the rotatable device, comprising a pair of central hubs for connecting the RLMS 14 to the rotating means, and providing rotary motion to the RLMS 14 wherein the load is sustained by Mount carrier base.

### CROSS-REFERENCE TO RELATED APPLICATIONS AND PRIORITY

The present application claims priority from an Indian Patent Application Number 201721030093 filed on 24 Aug. 2017 and PCT application PCT/M2017/055352 filed 6 Sep. 2017.

### TECHNICAL FIELD

The present disclosure relates to a field of storing thermal energy, and more particularly, to a concentrated solar power apparatus enabled to capture direct normal solar irradiance in the form of thermal energy and to store the thermal energy in the form of a heat source to be used for diverse applications.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Many concentrated solar power devices or plants are currently employed to generate solar power by using reflectors to concentrate a large area of sunlight to a small area. Such heat is generally stored or utilised to drive a heat engine or for any other purpose.

Concentrated Solar Power Technologies using imaging optics presently are of four types including Linear Fresnel Reflector with Absorber Tube, Solar Power Tower with Heliostats (mirrors with 2 axis tracking are called heliostats), Dish concentrating with receiver, and a Parabolic through with Absorber Tube. Further, existing technologies using flat imaging optics includes a Linear Fresnel Reflector with Absorber Tube and a Solar Power Tower with Heliostats.

Out of the above two technologies using the flat imaging techniques, the Solar Power Tower generates the highest degree of temperature which is surrounded by mirrors reflecting light onto a centrally elevated tower with the receiver at the focal Point of the array of heliostats. The solar power tower generates heat of about 650° C. By transferring the reflected concentrated solar irradiation to molten salt, steam is produced in the secondary heat exchanger that expands on a turbine to generate the intended electricity.

On the other hand, the Linear Fresnel Reflector with Absorber Tube may either be an old Linear Fresnel Reflector system or a new Compact Linear Fresnel Reflector. The new Compact Linear Fresnel Reflector consists of parallel rows of reflectors or mirrors and an absorber tube running around the focal point. Molten salt flows through the absorber which runs directly through the focal point of the mirrors. The Linear Fresnel arrangement approximates the parabolic shape of trough systems and temperatures of about 550° C. are achieved. This molten salt is used as a heat source to generate steam and produce power.

In general, viable concentrated solar power technologies use imaging optics and the technologies envisage the design for concentrating the solar irradiance on to a point called a focal point. Referring to FIG. 7 and FIG. 8, a regular or compact linear Fresnel reflector and a Heliostat field are illustrated, respectively, wherein the Principle design consideration effectively envisages the array of reflectors to reflect incoming solar rays to either a point or a line or a circle i.e. effectively to a two-dimensional stationary Identity/Target through which the absorber tube or receiver is placed. Such Consideration along with the principles of geometrical optics leads to a condition, wherein, depending on the size of the reflector, infinite numbers and positions of reflectors can be derived.

The non-Imaging optics technique enabled concentrated solar power is being used for ultra-high temperature furnaces. One such example is the Wakasa Wan Energy Research Centre (WERC) solar furnace as illustrated in FIG. 9. The solar furnace system consists of one giant Fresnel Lens having 9 members, each of the members being 1300 mm×1300 mm×5 mm thick. The system has a 2-axis tracking facility. The furnace can produce more than 10 kW and a temperature of about 2500⁰ C. at the focal point. The Largest Fresnel Lenses are being manufactured by Japanese Company NKTJ Co. Ltd. Referring to FIG. 12, a giant lens 5 mtrs×4 mtrs is illustrated. The Technological Trend in the Non-Imaging CSPs is to use Larger Fresnel lens.

Riken and Da Vinchi Co. Ltd., a Japanese Company, are using Fresnel lenses to generate heat for running rotary heat engines. The Japanese Company's work is based on the principle of rotary heat engine wherein the Fresnel lenses are mounted on a fixed structure. Referring to FIG. 10 and FIG. 11 illustrate and describes their principle for the elevation tracking which are claimed and have patented a fixed polygon sun house “a semi sphere made up of Fresnel lenses cut in a polygon shape and having no moving parts”.

However, it has been observed that the Concentrated Solar Powers (CSP) using imaging optics has multiple drawbacks. One the primary drawback is that efficiencies of imaging type of solar concentrators are very low. Such low efficiency is due to the distances between the reflectors and receivers. The huge reflectors are generally mounted on monopoles with tracking devices. Many a times, a slight variation in reflecting angles due to wind may cause the reflected beam to miss the target receiver. Maximum concentration achieved is about 15% to 20% of the theoretical maximum for the design acceptance angle. A considered view among research scholars is that the possibility of approaching the theoretical maximum may be achieved by using more elaborate concentrators based on non-imaging optics.

A research paper published in 2010, by Scholars, Nixon, J. D.; Dey, P. K.; Davies, P. A. from Aston University, Birmingham, UK on the India specific subject “Which is the best solar thermal collection technology for electricity generation in north-west India? Evaluation of options using the analytical hierarchy process.” In: Energy, Vol. 35, No. 12, 12.2010, p. 5230-5240. concludes as follows: “The study concludes that the linear Fresnel lens with a secondary compound parabolic collector, or the parabolic dish reflector, is the preferred technology for north-west India.”)

Because of the inefficiencies of the technologies using imaging optics, the plant size for a rated capacity must be increased substantially to meet the committed required thermal energy storage. Such drawback substantially increases the land requirements and plant costs. This leads to economically unviable small scale CSPs using imaging optics. Most of the existing CSPs have exposed reflectors covering enormous areas thereby, requiring continuous cleaning. Further, damage due to natural causes is also an issue.

Further, the historical/traditional non-imaging optics based CSPs suffer with their own limitations. For example before the commercial production of Fresnel lenses in these CSPs, using industrial grade plastics. Only convex glass lenses were as an alternate option available. The limitation of these convex lenses is that these they are very heavy and bulky to be used for the CSPs. In most of the experiments using the Fresnel Lenses for heating and TES applications, there exists a concept of increasing the size of the lens. The increased size causes major problems by way of handling of both, the large lenses and the high temperatures achieved at the focus. The large lenses are made of PMMA, a type of plastic and are exposed to the natural environment. Additionally, physical protection of these lenses is a big issue and many a times the whole contraption is enclosed in an enclosed Structure capable of sliding out wherein such contraption is introduced such that the lens do not interfere with the working of the solar furnace. Such system is affordable and acceptable for an experimental set up but not for commercial applications.

### SUMMARY

This summary is provided to introduce concepts related system and method for operating a managing discharge from a pump remotely and the concepts are further described below in the detailed description. This summary is not intended to identify essential features of the claimed subject matter nor is it intended for use in determining or limiting the scope of the claimed subject matter.

In an embodiment, a Concentrated Solar Power (CSP) apparatus to capture Direct Normal Irradiance (DNI) in form of thermal energy and to store the thermal energy in the form of a heat, in a plurality of Thermal Storage Material (TES), to be used as a heat source is described. The apparatus may further comprise at least one Fresnel Lens Tunnel (FLT), having a predefined diameter and a predefined length, to concentrate DNI in form of hotspots on an inscribing receiver. The apparatus may further comprise the receiver containing a re-circulating TES material and having a predefined radius and a predefined length, the receiver further comprising an inlet port, a tubular body providing for the heating surface and an exit port, wherein the inlet port is fixed to an inlet manifold by fixing means and the exit port fixed to an exit manifold by fixing means and the receiver is placed horizontal to the surface of the earth, in the North-South direction, enabling the hotspots to be generated along the predefined length and the periphery of the cross-sectional area of the receiver, enabling the TES material to be heated in the tubular body, and wherein the receiver is one of a single pass tubular body or a multi pass tubular body. The apparatus may further comprise the FLT comprising, at least three non-imaging concentrating optical elements, each having a predefined height h, a predefined width w and a predefined focal length f, placed with the height h tangential to the circle encompassing the predefined FLT diameter to form a FLT having N sides, wherein N is equivalent to a plurality of the number of non-imaging optical elements placed with height h tangential to the circle encompassing the predefined FLT diameter, held with a desired degree of freedom enabled for in and out radial movement, moving each side of the FLT parallel to the predefined length of the receiver and held by sliding means, to vary the radial distance of the hotspot generated, provided on a mounting structural member of a rotatable device, wherein the radius of the FLT is equal to the sum of the radii of the receiver, the focal length of the non-imaging concentrator element and an allowance, the allowance being equal to the enabled in and out radial movement of the sides of the FLT and the predefined FLT length is equivalent to the sum of a plurality of at least one predefined width w, and having the capability of being rotated concentric around the inscribing receiver by the rotatable device, by rotating means. The apparatus may further comprise at least one Enveloped Linear Fresnel Reflector (ELFR) to power each side of the FLT which is not receiving DNI, further one reflector for each of the side of the FLT not receiving DNI, wherein each reflector has the predefined length of the FLT, fixed in position by fixing means to a fixing structural member of the rotatable device such that the incoming solar rays are reflected off the respective reflectors in a direction towards and normal to the respective sides of the FLT and capable of being rotated by rotating means so as to rotate along with the rotatable device in unison along with the FLT. The apparatus may further comprise at least one Reflector and Lens Mount with Shield (RLMS), the rotatable device, comprising a pair of central hubs for connecting the RLMS to the rotating means, and providing rotary motion to the RLMS, the mounting structural member for mounting the FLT by sliding means, the fixing structural member for fixing the ELFR by fixing means and capable of being rotated by the rotating means, in unison along with the FLT and ELFR, concentric around the receiver and provide for Elevation Tracking so as to maintain the hotspots generated on the receiver. The apparatus may further comprise at least one Main Carrier Base (MCB) comprising a primary load bearing hollow Cartesian device and apparatus to accommodate and bear the load of the FLT, the ELFR, the RLMS, the receiver, and a complete re-circulating circuit of the TES material from the insulated silo through the receiver and back to the silo further comprising a hollow floating base held securely through the Center of Mass, with a desired degree of rotational freedom, by rotating means, about an axis normal to the surface of the earth and passing through the center of mass of the MCB and connected with hollow vertical columns with a height so as to admit the RLMS fixed with the ELFR, by fixing means and with a width between the columns, so as to admit the RLMS rotating means, held with a degree of rotational freedom, by holding means, to the RLMS hub on one side and fixed to the MCB on the other side by fixing means supported by a pair of horizontal stabilizer beams, fixed to hollow base by fixing means and holding on to a circular guide rail fixed, by fixing means, on top of an Insulated silo, containing the re-circulating TES material, coupled with a rotating device to give a rotary motion to the MCB, by rotating means, with a minimum of +/−23⁰ about the Solar Equinox, around an axis normal to the surface of the earth for providing the required Azimuth tracking to the FLT CSP.

### BRIEF DESCRIPTION OF FIGURES

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates a spot Fresnel lens with its the sectional view on the right is illustrated in accordance with an embodiment of the present subject matter.

FIG. 2 illustrates a linear Fresnel lens in accordance with an embodiment of the present subject matter.

FIG. 3 illustrates a focus profile of a linear and spot Fresnel lens in accordance with an embodiment of the present subject matter.

FIG. 4 and FIG. 5 illustrate two different re-circulating mechanisms in accordance with an embodiment of the present subject matter.

FIG. 6 illustrates a sectional view of FLT CSP in accordance with an embodiment of the present subject matter.

FIG. 7 illustrates an arrangement of linear Fresnel lens reflectors and compact linear Fresnel lens reflector in accordance with an embodiment of the present subject matter.

FIG. 8 illustrates a Heliostat field in accordance with an embodiment of the present subject matter.

FIG. 9 illustrates a setup of non-Imaging optics for concentrated solar power Wakasa Wan Energy Research Centre (WERC) solar furnace with an embodiment of the present subject matter.

FIG. 10 and FIG. 11 illustrate two diagrams by Riken and Da Vinchi Co. Ltd., describing their principle for the elevation tracking which are claimed and have patented a fixed polygon sun house “a semi sphere made up of Fresnel lenses cut in a polygon shape and having no moving parts” in accordance with an embodiment of the present subject matter.

FIG. 12 illustrates a lens with a size 5 mtrs×4 mtrs in accordance with an embodiment of the present subject matter.

It must be noted herein that the above FIGS. 7, 8, 9, 10 and 11 depicts the prior methodologies/devices/apparatus utilized for concentrating the solar power. The figures depicted hereinafter are related to improved concentrated solar power as proposed by the present invention.

FIG. 13 illustrates a graphical representation of the FLT 12 concept in accordance with an embodiment of the present subject matter.

FIG. 14 illustrates a close up of a FLT 12 having an array of Lens Holders 31 with 4 lenses fixed on to each Lens Holder in accordance with an embodiment of the present subject matter.

FIG. 15 illustrates a triangular extruded FFLT 12′ and a FFLT 12′ extruded in 2 parts in accordance with an embodiment of the present subject matter.

FIG. 16 illustrates a close up of a manual arrangement comprising of a plurality of parallel slots 57 for sliding and fixing the Lens Holder 31 on the ELFR Lens Holder Mounting Ring 52 in accordance with an embodiment of the present subject matter.

FIG. 17 illustrates a close up of the powered mechanism using linear motion guides in accordance with an embodiment of the present subject matter.

FIG. 18 illustrates a concept and development of a FLT 12 apparatus in accordance with an embodiment of the present subject matter.

FIG. 19 and FIG. 20 illustrate the reason for not using the lens array number 2 and number 14 for reflecting DNI off the reflector 44 and concept of MFLT, in accordance with an embodiment of the present subject matter.

FIG. 21 illustrates an Example of the design for Maximum Theoretical Size of Reflector No 4 corresponding to Lens Array No. 4, for the FLT 12 in accordance with an embodiment of the present subject matter.

FIG. 22 and FIG. 23 illustrate an offset 46 between the Theoretical Reflector 44 Positions in accordance with an embodiment of the present subject matter.

FIG. 24 and FIG. 25 illustrate a manual arrangement in accordance with an embodiment of the present subject matter.

FIG. 26 illustrates a RLMS reflector and lens mount with shield in accordance with an embodiment of the present subject matter.

FIG. 27 illustrates gearbox body on to the MCB 5 Structure in accordance with an embodiment of the present subject matter.

FIG. 28, FIG. 29 and FIG. 30 illustrate the engaging structure gearbox, splined bracket and central hub in accordance with an embodiment of the present subject matter.

FIG. 31, FIG. 32 and FIG. 33 illustrate Altitude Tracking Tilt at AM, Noon and PM in accordance with an embodiment of the present subject matter.

FIG. 34 illustrates the feature of rotating and parking in the shield position of the RLMS 14 along with the MCB 5 during storm or rain and the MCB rotating mechanism.

FIG. 35 illustrates suitable arrangement which may be to build the Glass Dust Shield 66 in accordance with an embodiment of the present subject matter.

FIG. 36 illustrates connection of the receiver 7 with the Inlet manifolds 9 and Exhaust manifolds in accordance with an embodiment of the present subject matter.

FIG. 36A illustrates receiver in accordance with an embodiment of the present subject matter.

FIG. 36B illustrates an internal view of receiver and secondary suction pipes in accordance with an embodiment of the present subject matter.

FIG. 36C illustrates a multi pass receiver in accordance with an embodiment of the present subject matter.

FIG. 37 illustrates the Main Carrier Base (MCB) 5 in accordance with an embodiment of the present subject matter.

FIG. 38, FIG. 39 and FIG. 40 illustrate Azimuth tracking with suitable mechanism for rotary motion to the MCB 5 in accordance with an embodiment of the present subject matter.

FIG. 41 illustrates a MCB arrangement in parallel in accordance with an embodiment of the present subject matter.

FIG. 42 illustrates a MCB arrangement in series in accordance with an embodiment of the present subject matter.

### DETAILED DESCRIPTION

The present disclosure relates to devices and methods for storing thermal energy, more particularly, to a concentrated solar power apparatus to capture direct normal irradiance in the form of thermal energy and to store the thermal energy in the form of a heat source.

For the purpose of this invention “Thermal Energy Storage” (Also to be referred as TES) is a process by which thermal energy is stored in a storage medium.

For the purpose of this invention “Solar Concentrator” is an arrangement of mirrors or lenses which concentrate the solar irradiance or sunlight to predefined point. Such point is called the focal point (F). The technology used in Solar Concentrators to produce thermal energy for practical use as a heat source is called Concentrated Solar Power. Concentrated Solar Power (Also to be referred as CSP) technologies available industrially at present are classified as:

1. Reflective Type concentrators
2. Refractive Type concentrators

Wherein all Reflective Concentrators are essentially imaging optics. Imaging optics i.e. they reflect incoming solar rays and produce an image.

Commercially used Reflective Type Concentrators are:
i) Mirrors;
ii) Parabolic Trough;
iii) Linear Fresnel Reflectors
iv) Parabolic Dish

Furthermore, commercially available refractive type concentrators comprise Fresnel lenses which are refractive type concentrators and are non-Imaging optics. Concentrators using non-Imaging optics technology do not reflect but refract solar rays and concentrate incoming solar rays and produce a hot spot at their focal point. The Fresnel lenses are classified as Linear type or Spot type. The basic difference between the linear type or spot type is the profile of the refracting edges.

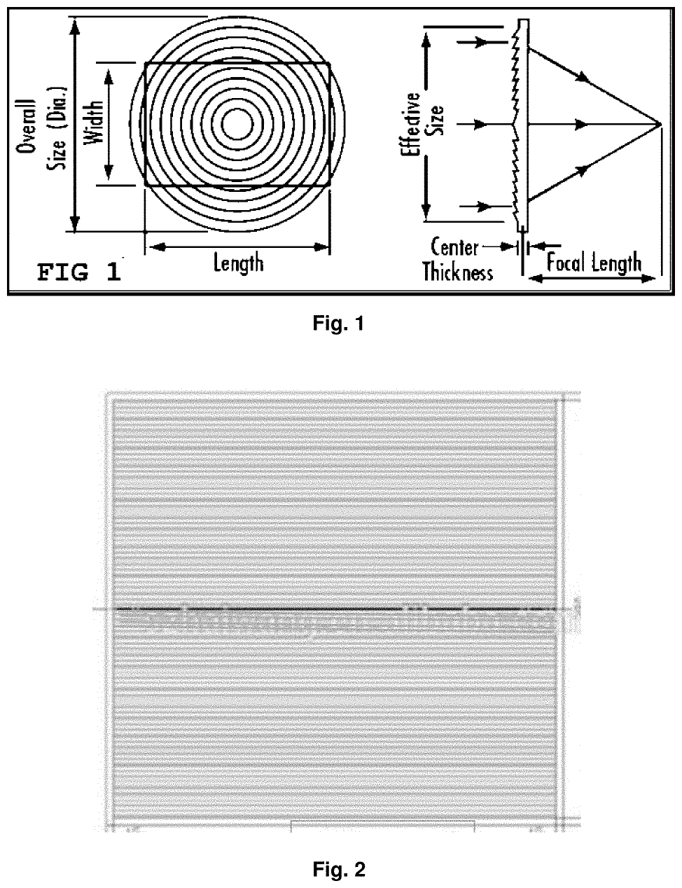

Referring FIG. 1, a spot Fresnel lens with its the sectional view on the right is illustrated in accordance with an embodiment of the present subject matter. There is a plurality of serrations for a spot Fresnel lens in circular pattern.

Referring FIG. 2, a linear Fresnel lens is illustrated in accordance with an embodiment of the present subject matter. There is a plurality of serrations for a linear Fresnel lens are in a parallel pattern.

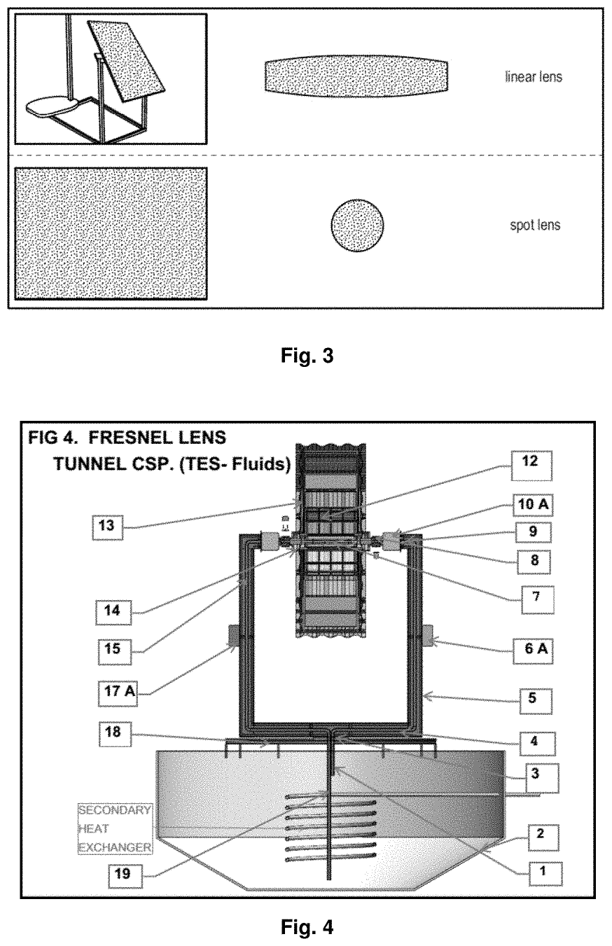

Referring FIG. 3, a focus profile of a linear and spot Fresnel lens is illustrated in accordance with an embodiment of the present subject matter. The linear lens may have a focus profile along the length of the serrations. The focus profile may be similar to a thick line. The spot lens may have a focus profile which is a well-defined illuminated spot. For a given size, the spot focus Fresnel lens may achieve far higher temperatures than linear focus Fresnel lenses. Commercially available Fresnel lenses are injection molded or in some cases machined in a variety of industrial plastics further comprising an Acrylic (Poly methyl methacrylate also known as PMMA). As industrial plastics are mass produced, they are comparatively cheaper than glass lenses.

For the purpose of this invention a “Receiver” may be a container carrier which contains an energy storage material flowing through the receiver and is placed on the Focal Point (F) of the Solar Concentrator. Other nomenclatures used for the receiver are terms like absorber tube and absorber.

For the purpose of this invention the “Energy Storage Medium” disclosed in the receiver may be a re-circulating material or medium which is heated by the solar concentrator. On heating, the energy storage medium may or may not change its phase. The energy storage medium may comprise water, special molten Salts or high temperature oil. Presently, the costs of the special energy storage mediums are very high and in some cases the cost may comprise up to about 60% of the cost of a Concentrated Solar Power Plant. To reduce the cost of such CSP plants, materials comprising sand, Alumina, concrete, fly-ash is being researched for their thermal energy retaining abilities, availability and cost factors. The energy storage medium is stored in a plurality of insulated silos 2 which usually have a secondary heat exchanger for further transfer of heat.

For the purpose of this invention a “Tracking System” may be employed for achieving maximum possible efficiencies in concentrating the solar energy wherein a solar concentrator surface should be continuously aligned at the desired angle to the sun irradiance i.e. sun rays. This Continuous alignment is achieved by an apparatus known as Solar Tracking System. The parameters to be tracked by the tracking system are the Azimuth angle and the Elevation angle.

For the purpose of this invention a “Direct Normal Irradiance” (also to be referred as DNI) is the amount of solar radiation received per unit area by the surface that is always held perpendicular to the rays that come in a straight line from the direction of the sun at its current position in the sky. For Calculations, a Standard Data of 1000 W/hour for 6 hours is used.

This present invention relates to a mechanical apparatus for the construction of a family of a Fresnel Lens Tunnel 12 Concentrated Solar Power (Also to be referred as FLT 12 CSP), apparatus to capture solar irradiance and store the thermal energy in form of heat in TES Materials including, but not limited to, molten salt, sand, alumina, fly ash, and the like to be further used as a heat source. This device and apparatus uses Imaging and non-Imaging optics and the principles of Azimuth & Elevation tracking to achieve the task of concentrating solar irradiation, as hotspots. The hotspots 77 are generated along the periphery of the cross-sectional area of the receiver 7 placed horizontal to the surface of the earth and in the North-South direction.

The apparatus may further comprise a Fresnel lens tunnel 12 which is a mechanical arrangement operating on the principles of geometrical optics, and having an array of at least 3 numbers of non-imaging optical elements capable of condensing incoming solar irradiance to a predictable condensed area for further concentration or to a predicable focal point and hotspot profile. The non-imaging optical elements may be further held in position with a degree of desired freedom for radial movement by sliding means around a stationary or a rotatable receiver 7 on an imaginary inscribing circle having a radius nearly equal to the sum of the radii of the receiver 7 and the focal length of the non-imaging optical device and being capable of being rotated around the receiver 7. The maximum temperature that may be sustained by the material of the receiver 7 may decide the intensity of the heat to be generated at the hotspot 77 which may further allow to decide the exact radius of the inscribing circle. One such mechanical arrangement may be an array of 3 Fresnel lenses. The Fresnel lenses may be a spot type or a linear type Fresnel lens or a combination of both. In another embodiment, the Fresnel lenses may be a Silicon on Glass (SOG) type Fresnel lens.

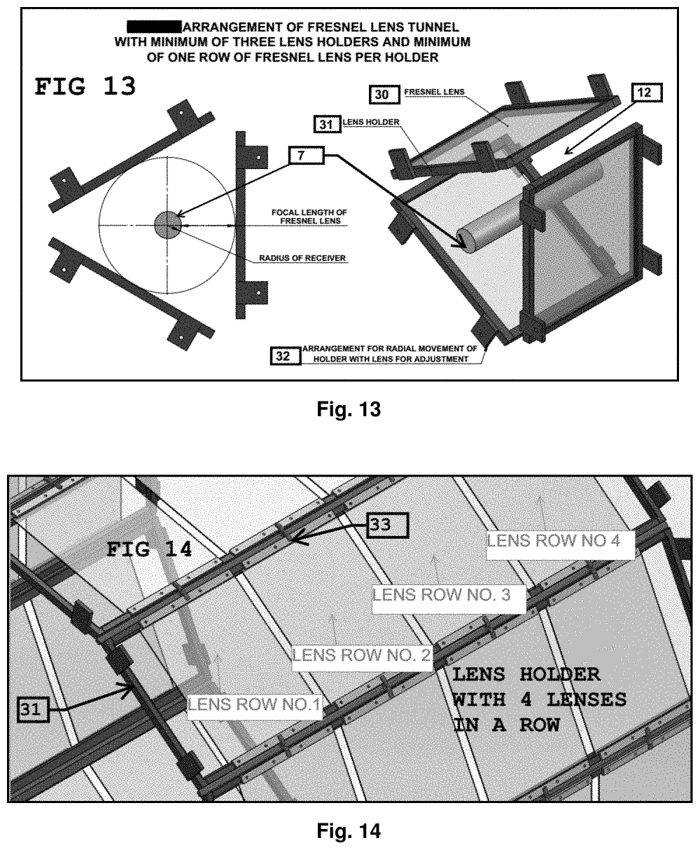

Referring FIG. 13, a graphical representation of the FLT 12 is illustrated in accordance with an embodiment of the present subject matter. As shown, each lens is fixed in a Lens holder 31 and each Lens holder 31 may hold one lens.

Referring FIG. 14, an FLT 12 having an array of Lens Holders 31 and 4 lenses fixed on to each Lens Holder 31 (which is effective to 4 Rows of lenses in each Lens Holder 31) is illustrated, in accordance with an embodiment of the present subject matter.

In an embodiment, the mechanical arrangement of the Fresnel lens tunnel may further comprise a tunnel shaped apparatus produced as a whole or produced in parts and assembled together by fixing means as an assembly and having at least 3 sides wherein each side is capable of mimicking a non-imaging optical element further capable of condensing incoming solar irradiance to a predictable focal point and hotspot profile.

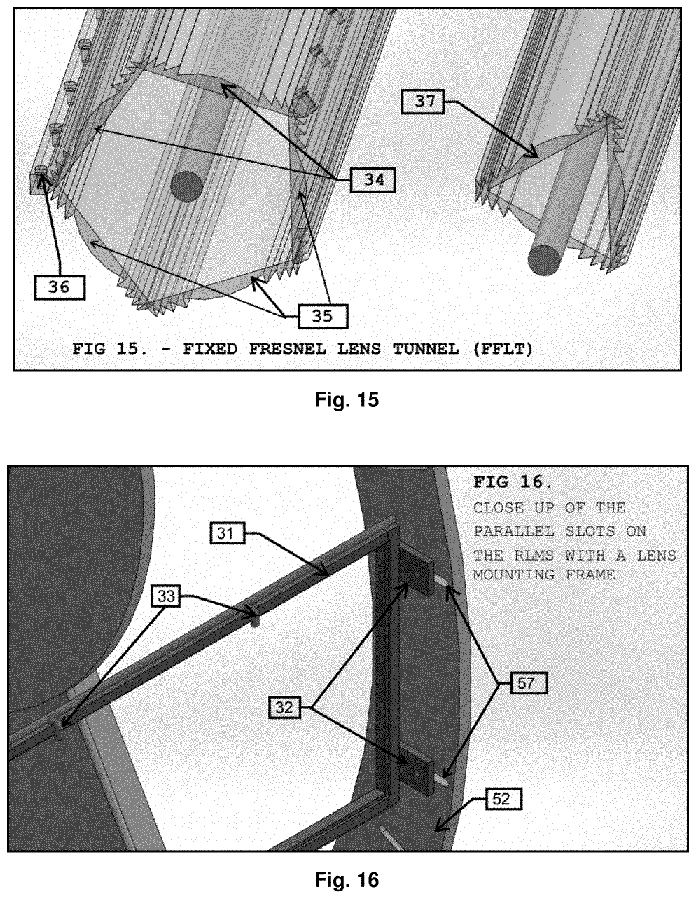

In another embodiment, the Fresnel lens tunnel may be an extruded triangular profile as a whole or in parts and assembled together 37 with bolts as illustrated in FIG. 15, made of acrylic or any other industrial plastics/glass/material, having the required serrations machined or extruded on to its surfaces. In this case the focal length of the Fresnel lens tunnel will be fixed and the length of the device can be varied as per the requirement. Such apparatus may be referred as Fixed Fresnel Lens Tunnel (hereinafter referred as FFLT and referenced with reference numeral 12′).

Referring FIG. 15, a triangular extruded FFLT 12′ and a FFLT 12′ extruded in 2 parts which is assembled with bolts in a pentagonal shape is illustrated in accordance with an embodiment of the present disclosure.

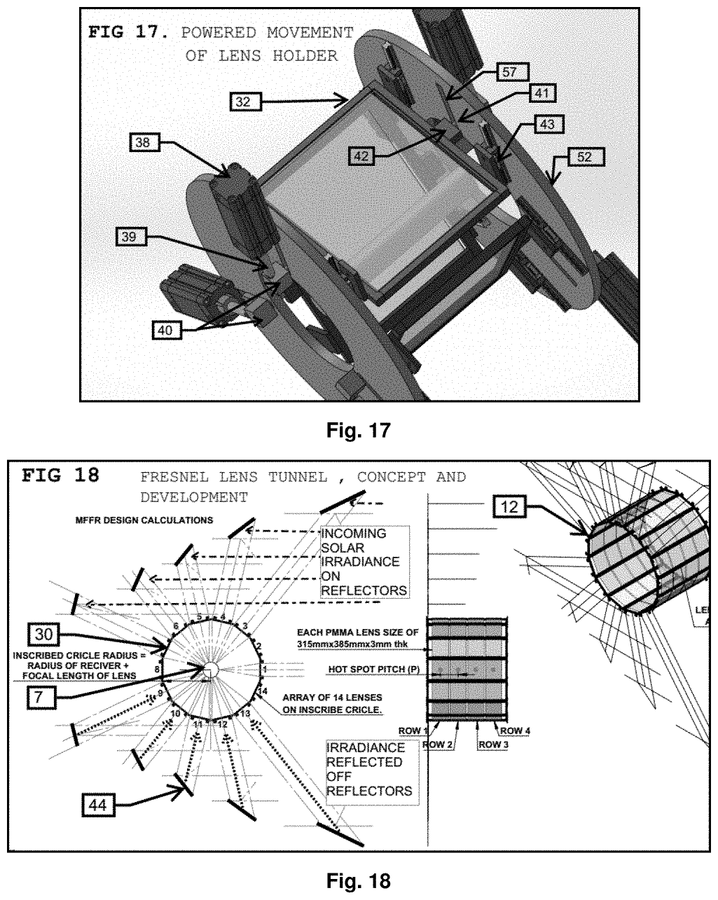

In an embodiment, in case of a FLT 12 for fine adjustment of the focal point on the receiver 7, each Lens holder 31 with lenses is capable of being moved in or out in the radial direction. Such capability to radially move the holder 31 may be either manual or powered. Referring FIG. 16 which illustrates manual arrangement comprising of a plurality of parallel slots 57 facilitating sliding and fixing the Lens Holder 31 on the ELFR Lens Holder Mounting Ring 52 with nuts and bolts. In an embodiment, a powered capability may provide an advantage as solar concentration can be changed as per requirement and demand. The requirement may further comprise an increase in concentration in the morning & evening when irradiance is weak and further a decrease in concentration during other times of the day. Referring FIG. 17, a powered mechanism using linear motion guides is illustrated wherein the Linear motion block 43 is fixed to the Lens Holder 31 and the Linear motion rail fixed to the ELFR Lens Holder Mounting Ring 52. A pneumatic cylinder 38 is mounted on the ELFR 13 Ring and a pneumatic cylinder rod 39 connected to the Lens Holder 31 with a pneumatic cylinder block 40 and a pin 41 passing through a slot on the ELFR 13 Ring. The movement of the cylinder from BDC to TDC may provide desired results of focal length variation. In case of a FFLT 12′, the Focal Length is fixed and temperature to be achieved may be adjusted at design stage by varying the diameter of the Receiver 7.

In an embodiment, the diametric size of the FLT 12′ or FFLT 12′ and the number of rows of lenses in each holder 31 which is the length of the FLT 12′ or FFLT 12′ apparatus may decide the amount of energy concentrated by the module.

In another embodiment, the size of the lens may be a vital design aspect of the FLT 12′ module as it decides the Pitch (P), as shown in FIG. 18 which illustrates the distance between the hot spots generated along the length of the receiver 7. Pitch P for a spot lens will be a numeric value >0 and the Pitch P for a linear lens will be 0.

Referring FIG. 13a concept of the FLT 12 with an array of 3 lens holders 31 is illustrated in accordance with an embodiment of the present subject matter.

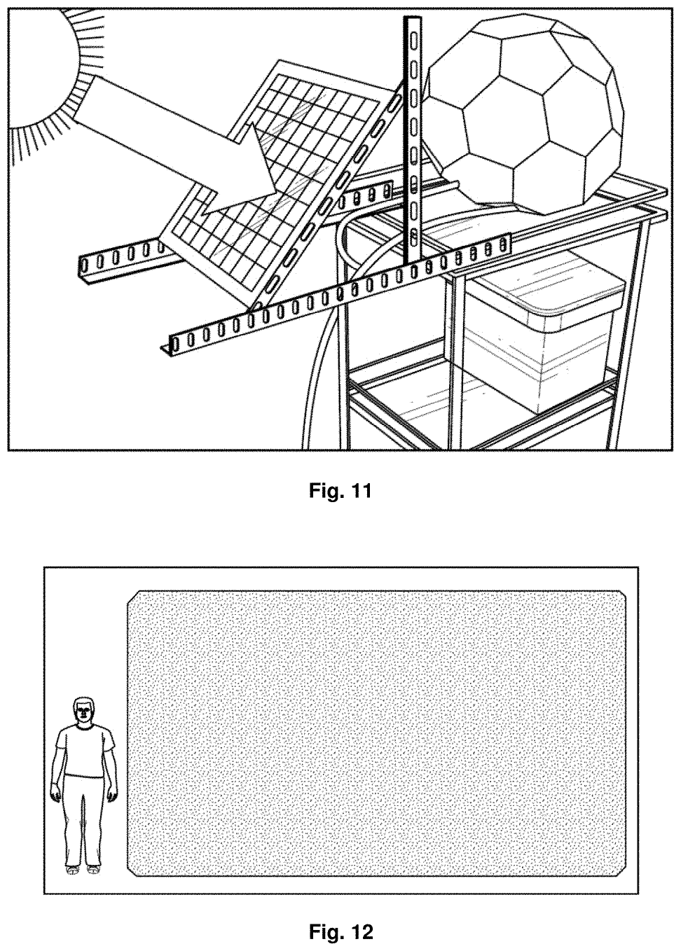

Referring FIG. 18, a concept and development of a FLT 12 module and an array of reflectors 44 implemented to power the FLT 12 is illustrated in accordance with an embodiment of the present subject matter. In an embodiment, the FLT 12 module may be made with spot Fresnel lenses of size 315 mm (width)×385 mm (height). Referring FIG. 18, The FLT 12 is described as an embodiment of the present subject matter further having an array of 14 lens holders 31 on an inscribed circle having a radius nearly equal to the sum of the radii of the Receiver 7 and the Focal Length of the Fresnel Lens. In an embodiment, each Lens Holder 31 may hold a row of 4 Lenses. The total area of the Lenses may measure 6.7 mtr². A preferred nomenclature for describing the above FLT 12 with Spot Fresnel lenses is 0.315×0.385×4P0.315, 6.7 mtr² and with Linear Fresnel Lenses is 0.315×0.385×4P0, 6.7 mtr². Further, the nomenclature describing the triangular and pentagonal Linear FFLT 12 having a length of 2 meters and each side having a size of 315 mm in FIG. 11.1.A is 0.315×S3×2×P0, 1.89 mtr² and 0.315×S5×2×P0, 3.15 mtr².

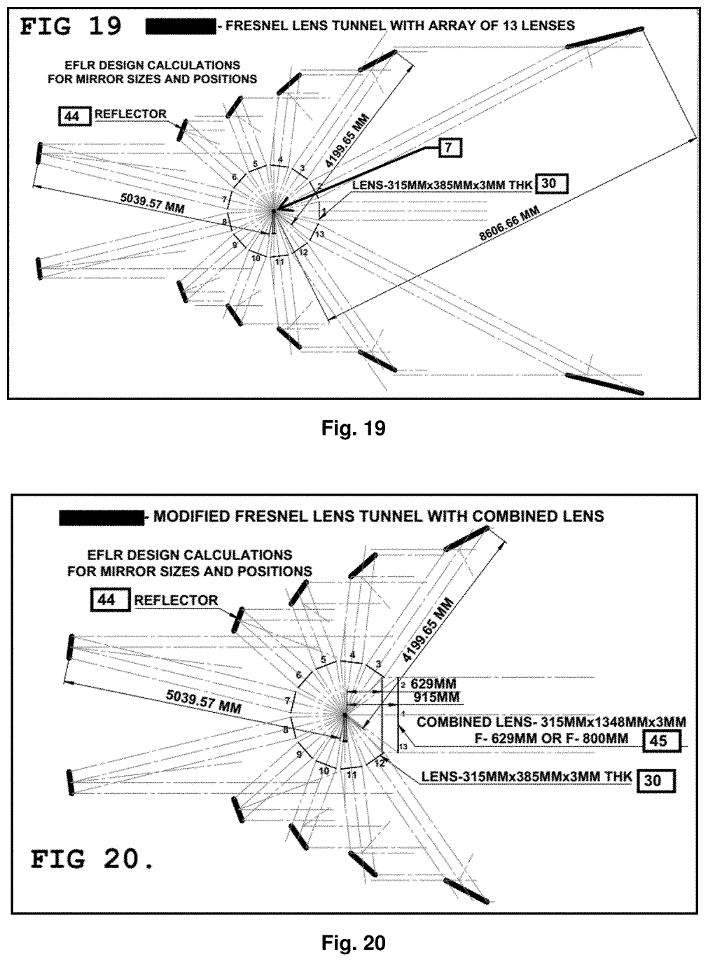

In another embodiment, the incoming Direct Normal Irradiance which are the normal solar rays are reflected from Reflectors 44. Each reflector 44 may be designed specifically for a Lens Holder 31 forming a lens array so that the reflected rays are normal to surface of the lenses held in the Lens Holder 31. Due to geometrical constraints, Lens array number 8 cannot be used to reflect light. Furthermore, FIG. 19 and FIG. 20 illustrate the reason for not using the lens array number 2 and number 14 for reflecting DNI off the reflector 44.

Referring FIG. 19, an elimination of Lens Array Number 8 is illustrated, as it could not be used which further leads to the design of FLT12 having 13 lens arrays. The area of the FLT 12 is now 6.3 mtrs² and the number of hotspots generated are 13×4=52. In an embodiment, the development of the respective reflectors 44 may show the radial distance of reflectors 44 for lens array numbers 2 and 13 from center of the Receiver 7 as 8300 mm and radial distance of reflectors 44 for lens array numbers 3 and 12 from center of the Receiver 7 as 4199 mm (similar to lens array number 2 & 14 as illustrated in a FIG. 18 which is the FLT 12 with 14 lens arrays). Use of reflectors 44 for Lens Array Numbers 2 &13 may almost double the size of the apparatus holding the array of the reflectors 44 and other dependent components. Thus, there is a need for a balance between the size, stability, economics and the ease of handling of the apparatus holding the array of reflectors 44 and other dependent components, which may lead to the development of a Modified Fresnel Lens Tunnel (also to be referred as MFLT 12″) as illustrated in FIG. 20. In an embodiment, similar modification may be carried out for a FFLT 12′ also.

Referring FIG. 20, which illustrates the development of the modified Fresnel lens tunnel (MFLT 12″) which eliminates the need to cater to lens arrays needing reflectors 44 at large radial distance comprising a radial distance of 8300 mm for lens array numbers 2 and lens array number 13 in FLT12 as illustrated in FIG. 19. Furthermore, comparing FIG. 19 and FIG. 20, it is noted that the Lens array numbers 1, 2 and 13 are replaced by a single Combined Lens array using a Modified Lens 45. A Modified Lens 45 is produced by keeping a similar focal distance and similar width (so as to have a similar focus Pitch P) as that of lens in lens arrays 1, 2 and 13, but having a height so as to accommodate the Modified Lens 45 in a frame to be fixed between the frames of lens array numbers 3 and 12. In the present embodiment, the Size of the lens has been modified to 1348 mm×315 mm×3 mm thick. FIG. 20 further illustrates the examples of 2 lenses having focal length of 800 and 629 mm. Any such lens may be used as a Modified Lens 45. Therefore, now the area of the MFLT 12 is {(0.135 mtr×0.385 mtr×10)+(1.348 mtr×0.315)}×4=6.549 mtrs². It must be concluded that the area of the MFLT 12″ has increased as compared to the corresponding FLT 12 but the number of hotspots have come down from 52 to 44 i.e. (10×4+4). In an exemplary embodiment, same Procedure may be used to Modify any adjacent Lenses like Lens array numbers 6, 7 and 8, 9 (in FIG. 20) to get a smaller ELFR 13 and RLMS 14 but with reduced hotspots.

The Theoretical Thermal Concentration Capacities of the FLT 12 or MFLT 12″ may be calculated using standard available DNI data. Considering a DNI of 1000 w/h/m² of solar irradiance for a minimum of about 6 hours per day, the abovementioned modified FLT 12 having an area of about 6.549 mtr² can produce about 6.549 mtr²×1000 watts/mtr²/hour×6 hours/day=39,294 w per day or 39.29 KW/day.

In an implementation, design Objectives of a Linear Fresnel Reflector 44 is disclosed. A Regular or Compact Linear Fresnel Reflector 44 or a Heliostat Field may be primarily designed so that the array of reflectors 44 may reflect the incoming solar rays to a point or to a line or to a circle which is effectively to a stationary two-dimensional Identity, through which the absorber tube or receiver 7 is passed. The Principles of Geometrical Optics for reflecting on to a two-dimensional target/Identity may lead to a condition, wherein, for any given size of the reflector 44, infinite numbers and infinite positions of reflectors 44 may be derived.

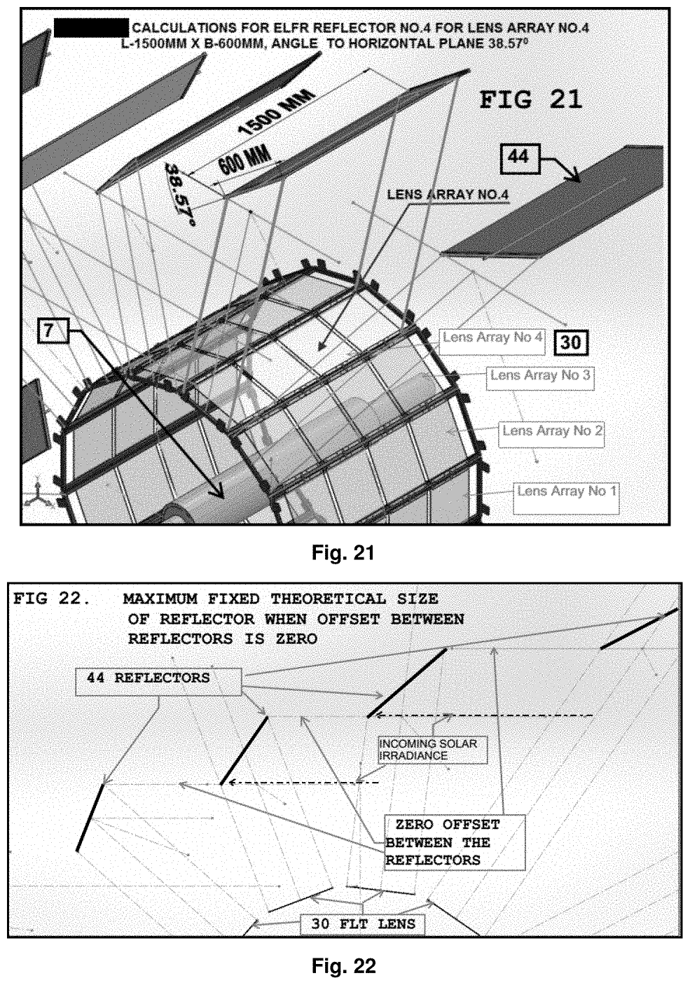

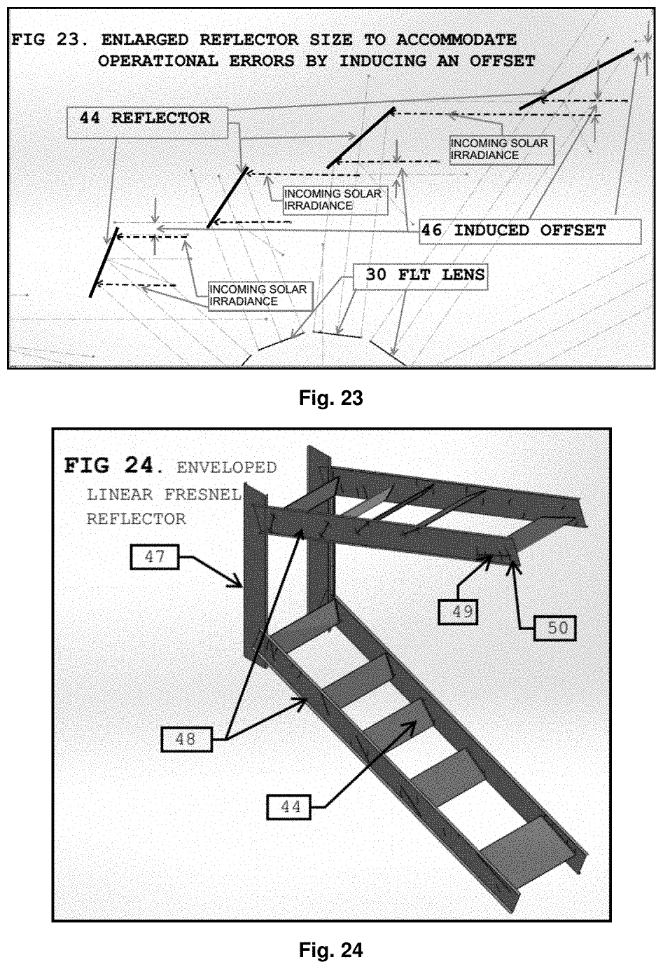

In another implementation, a design aspect of an Enveloped Linear Fresnel Reflector 44 (ELRF) is disclosed. As disclosed above the apparatus holding the array of the reflectors 44 is referred as Enveloped Linear Fresnel Reflector (ELFR 13). In an embodiment, designing an ELFR 13 for a FLT 12 or MFLT 12″ or FFLT 12′ as the case may be, may envisage each reflector 44 member of the ELFR 13 to be designed so that the incoming rays are reflected off by corresponding reflectors 44 at an angle normal to the corresponding row of lenses i.e. an array of Lenses of the FLT12, wherein each Array of Lens has a fixed area and orientation which may be a plane having a three-dimensional identity. An Example of the design for Maximum Theoretical Size of Reflector No 4 corresponding to Lens Array No. 4, for the FLT 12 illustrated in FIG. 18 is further illustrated in FIG. 21 in accordance with an embodiment of the present disclosure. Considering the Principles of Geometrical Optics for reflecting of the incoming solar rays to a three-dimensional identity, only a fixed number of reflectors 44 having a Fixed Maximum Theoretical Size without producing a shadow on adjacent reflectors 44 may be accommodated in the array of Reflectors 44. In an embodiment, if required, this Fixed Maximum Theoretical Size of a Reflector 44 may be altered and made larger to accommodate for any manufacturing/operational errors by inducing an offset 46 between the Theoretical Reflector 44 Positions as illustrated in FIG. 22 and FIG. 23.

In another embodiment, the Basic Difference in the Design Considerations of a two-dimensional stationary identity in case of a Linear Fresnel Reflector 44 or a Heliostat and that of a three-dimensional rotating Identity as in case of the ELFR 13 may make the Enveloped Linear Fresnel Reflector 44 (ELFR 13) arrangement Unique mechanical arrangement and apparatus.

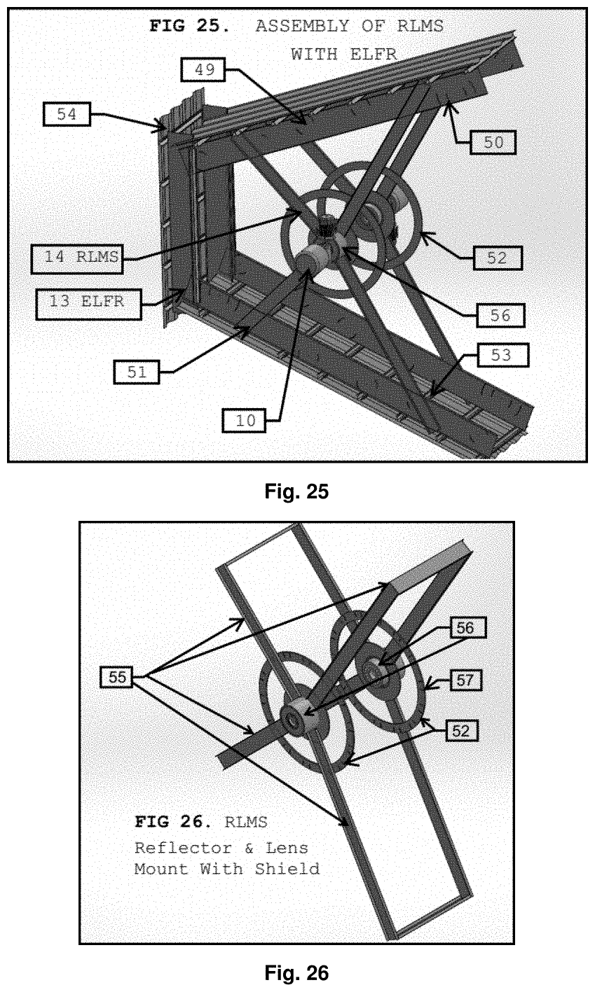

In yet another embodiment, the ELFR 13 is a mechanical apparatus built for a specific FLT 12 or FFLT 12 having an array of N lenses wherein N is a number greater or equal to three, and is constructed and formed by placing and holding the respective Reflectors 44 of each Lens Array in position by fixing means, so that the incoming solar rays are reflected off Respective Reflectors 44, in a direction towards the Respective Lens Array and normal to the surface of the respective Lens Array and is capable of being rotated, by rotating means, in unison along with the FLT 12 or FFLT 12′ around the receiver 7. For the fine adjustments of the incoming solar rays reflected off the Reflectors 44 and to overcome any manufacturing or operational errors additional capability is provided, by rotating means, for each Reflector 44 positioned in the ELFR 13 to be rotated and fixed in desired position about its own horizontal axis. This capability to rotate and lock the holders 31 may be either manual or motorized. As illustrated in FIG. 24 and FIG. 25, a manual arrangement is illustrated wherein each of the reflectors 44 is held securely in respective Reflector Holder 31 Frames and each of the Reflector Holder Frame is mounted on to an Angular Structural Member 48 component of the ELFR 13 and each of the Reflector Holder Frames can be rotated around a pivot 49 and fixed in position at their respective three dimensional positions by bolts through the circular slots 50 so as to provide the required fine adjustments. Therefore, the incoming solar rays are reflected off Respective Reflectors 44 perfectly normal to the Respective Lens Array and further to provide for corrections so as to overcome any manufacturing errors or warpage in the structure.

The Angular Structural Members 48 with the Vertical Structural Member 47 along with the Reflector Holders 31 and Reflectors 44 of the ELFR 13 are fixed rigidly on to the Reflector and Lens Mount with Shield Structure (RLMS 14) by fixing means 51 like nuts and bolts or rivets or welding, so that the array of Fresnel Lenses in the FLT 12 receive solar rays normal to the surface of each Lens array of the FLT 12 after being reflected off their corresponding Reflector 44, so as to maximize the solar concentration for each Fresnel lens. This ELFR 13 mounted securely on to the RLMS 14 along with the FLT 12 is rotated in unison about a Receiver 7 by a rotating mechanism and such rotation provides the required Elevation Tilt to maximize solar concentration. Such arrangement is further illustrated in FIG. 25.

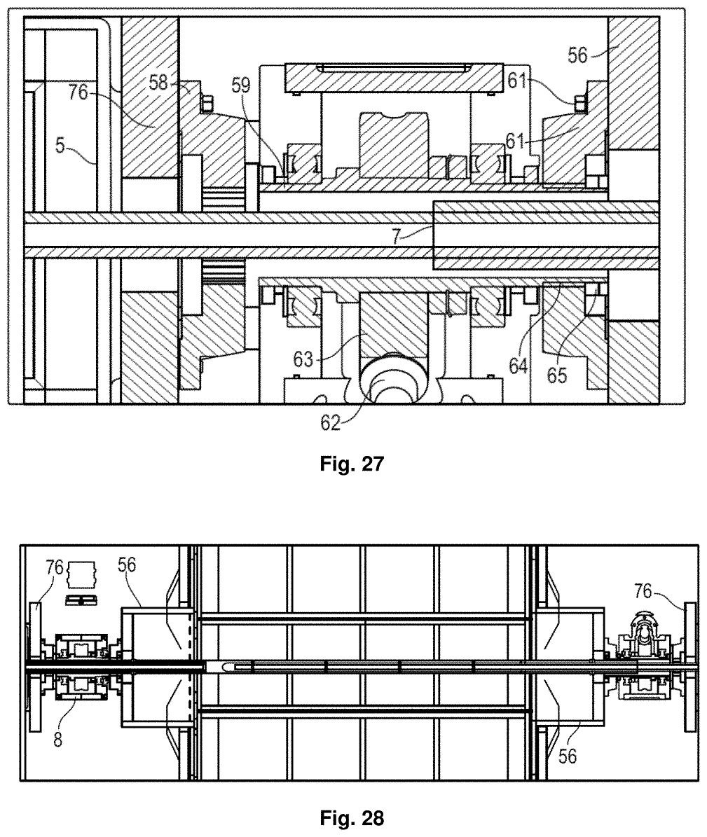

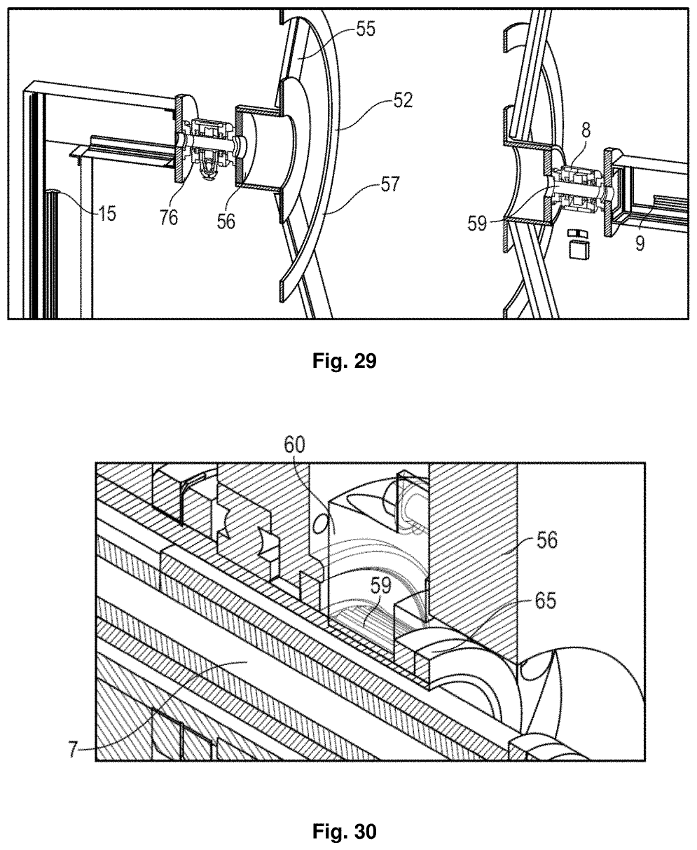

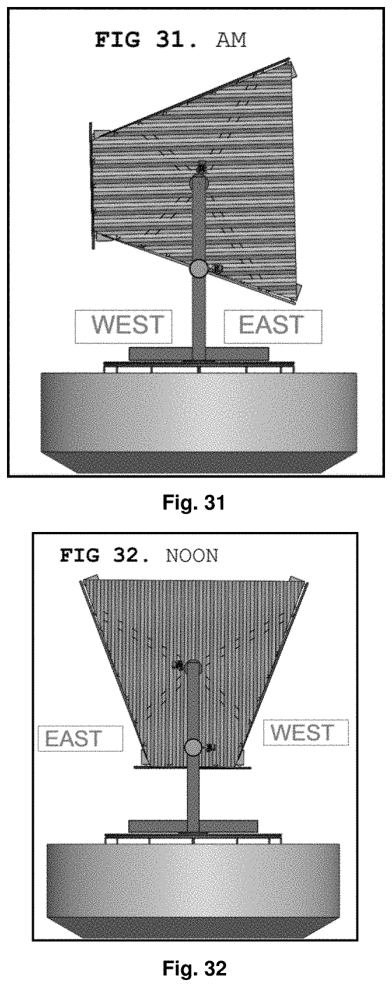

In an embodiment, the RLMS 14 is a mechanical apparatus provided for the mounting of the FLT 12 or MFLT 12″ or FFLT 12′ on the Lens holder 31 mounting ring 52 by a manual or powered arrangement. Such arrangement further comprising a manual arrangement is illustrated in FIG. 16 and a powered arrangement is illustrated in FIG. 17. Further, an arrangement for the RLMS 14 is illustrated in FIG. 26. The ELFR 13 may be mounted and fixed rigidly by fixing means like nuts and bolts or rivets or welding on the RLMS 14, through the ELFR 13 supporting struts 55. For mounting and rotating the RLMS 14 about its Central Hub 56, the RLMS 14 is connected with a Main Carrier Base (MCB 5) on both ends by suitable arrangements. A preferred arrangement using known mechanical components like a motor with a worm drive 62 and worm wheel 63 compatible Gearbox 8 wherein the gearbox body is bolted with a bracket 32 to the MCB 5 Structure named as gearbox mounting vertical plate 58 illustrated in FIG. 27. The gearbox 8 having an externally splined hollow drive shaft 59 is engaged and meshed with corresponding internally splined bracket 60 which is bolted by bolt 61 to the Central Hub 56 as illustrated in FIG. 27, FIG. 28, FIG. 29 and FIG. 30. Such Rotation of the RLMS 14, about its central hub 56, in unison with the FLT 12 or MFLT 12″ or FFLT 12′, along with the corresponding ELFR 13 while maintaining the relative position of the hotspots 77 generated on the periphery of the Receiver 7 provides for the required Altitude Tracking Tilt as illustrated in FIG. 31 for AM, FIG. 32 for NOON and FIG. 33 for PM.

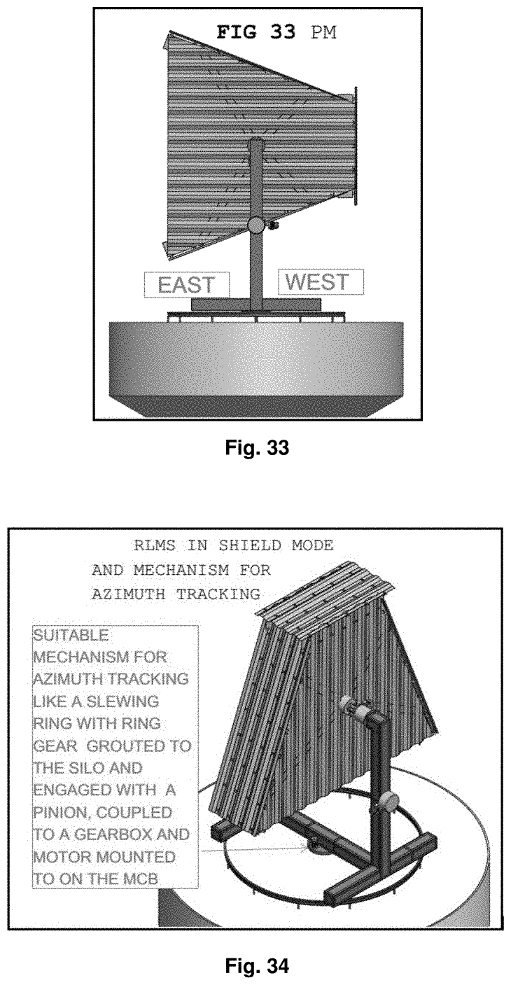

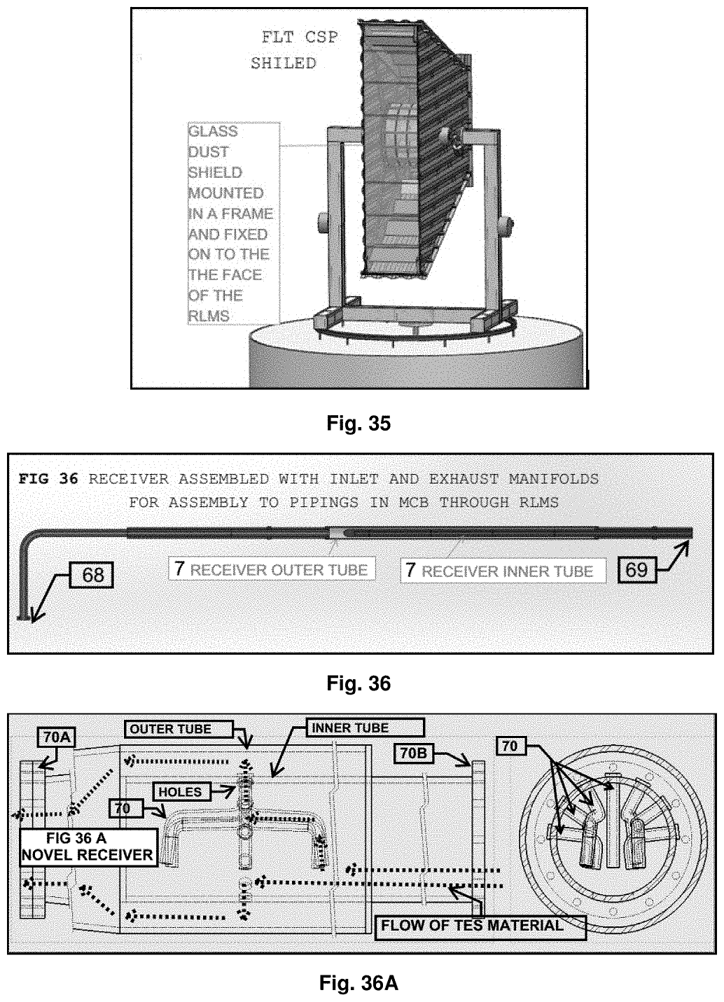

In an embodiment, one or more Reflector cleaning mechanisms in form of scrubbers or air jets 33 are illustrated in FIG. 14 are provided on the RLMS 14. Physical protection for the FLT 12, ELFR 13, and all other components is provided by enclosing the RLMS 14 by a suitable arrangement. One such suitable arrangement may be a plurality of corrugated sheets 54 mounted on Hat section 53 rafters for supports. On the frontal area, which remains exposed to the incoming solar rays, a Glass Dust Shield 66 may be mounted by a suitable arrangement. One such suitable arrangement may be to build the Glass Dust Shield 66 by mounting rectangular pieces of glass in a frame and this frame is fixed on to the RLMS 14 with nuts and bolts to protect the FLT 12/MFLT 12″/FFLT 12′ and the ELFR 13 and other components as illustrated in FIG. 34. In case of a storm or rain the RLMS 14 along with the MCB 5 may be rotated and be parked in the shield position as illustrated in FIG. 35.

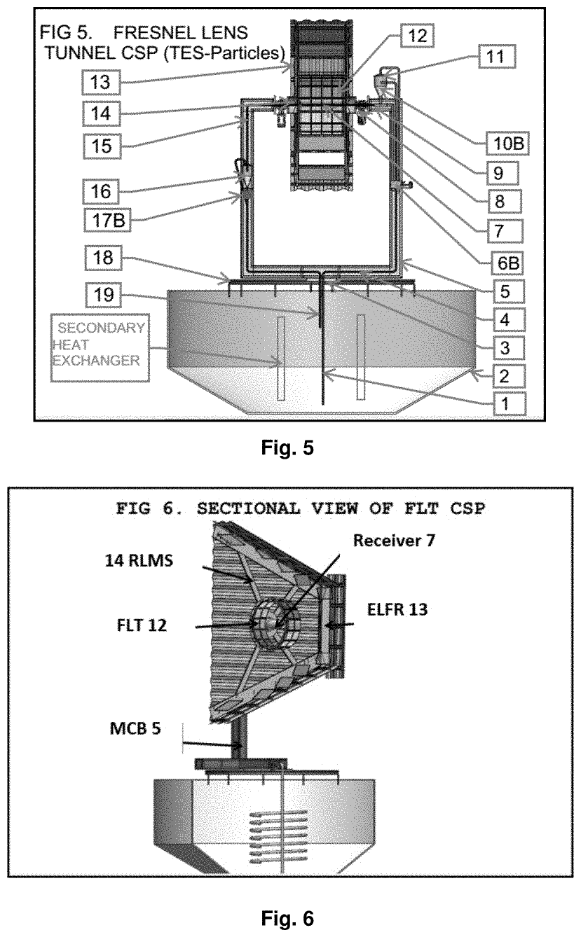

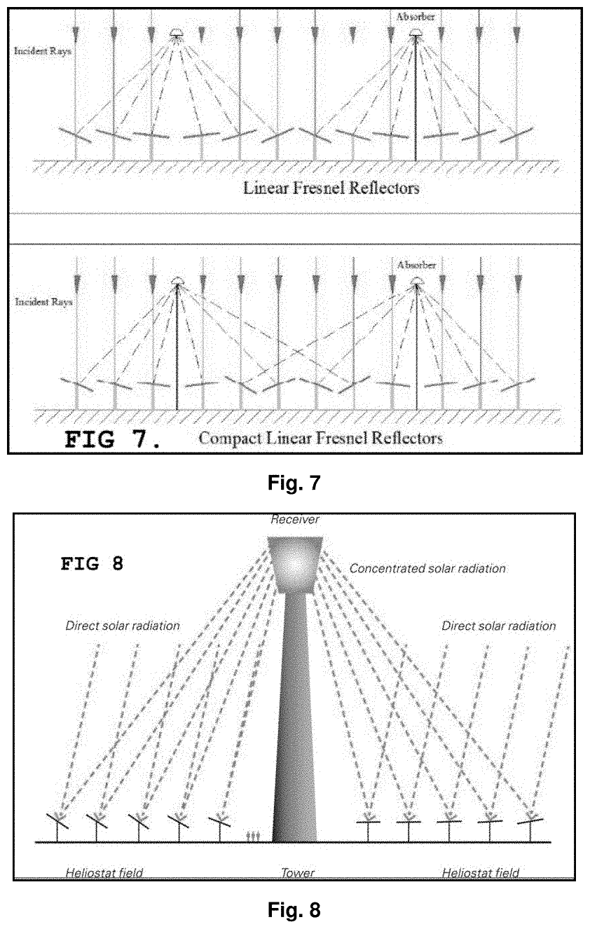

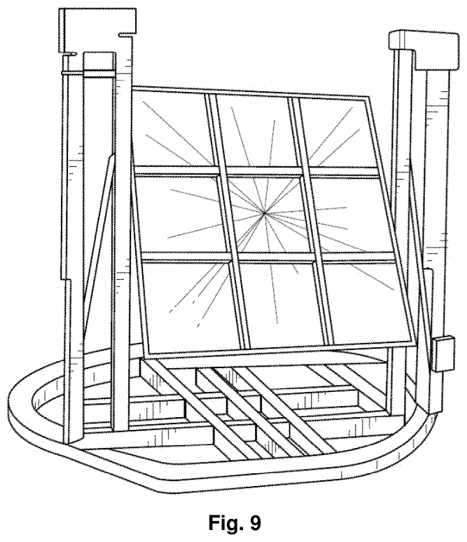

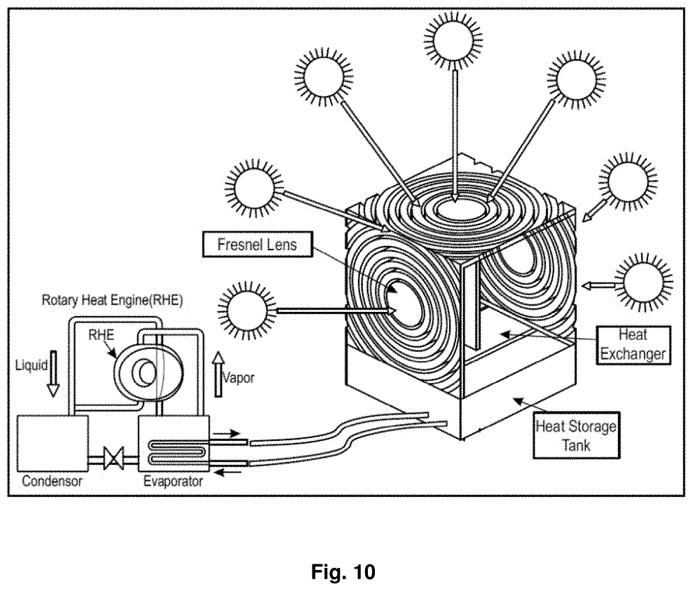

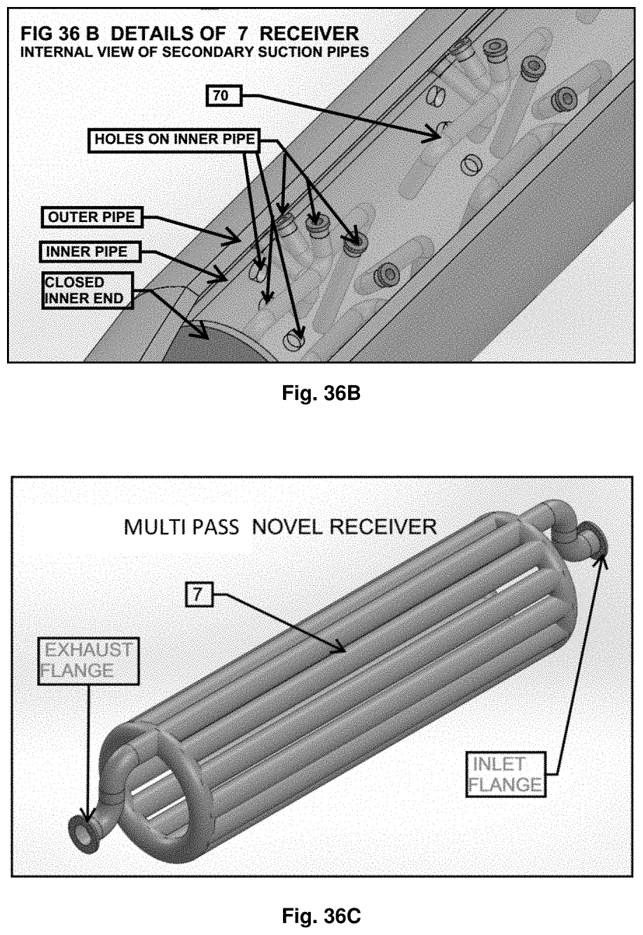

In yet another embodiment, the Receiver 7 is preferably a heat exchanger. The Receiver 7 is designed as per the TES material chosen to be used in The FLT CSP. The choice of the TES material decides the Conveying Mechanism for moving the TES material through the FLT CSP system which is from the insulated silo 2 through the suction pipe 1, inlet manifold to the end connection of the inlet pipe 69 followed by the receiver 7 further followed by the end connection of an exhaust pipe 68 and further followed by the discharge pipe 19 and back to the Silo 2. This Conveying Mechanism decides the components to be used in the circuitry. Referring FIG. 4 and FIG. 5, two different re-circulating mechanisms are illustrated. FIG. 4 depicts a hydraulic conveying mechanism for fluids wherein industrial components like hydraulic pumps, various types valves, sensors 10A place in the drum and the like are used to circulate the TES Fluid. FIG. 5 illustrates a Differential Pressure conveying mechanism for fine particles like fly-ash, alumina, sand wherein industrial components like vacuum pump 6Bs/blowers, termination vessels 10B, valves, sensors and the like are used. The Receiver 7 is connected between the inlet manifold 9 and exhaust manifold 15 using a suitable arrangement which passes through a hollow drive shaft 59 rotating the RLMS 14. An arrangement using flanges and nuts and bolts for connecting the receiver 7 with the Inlet manifolds 9 and Exhaust manifolds 15 and pipes are illustrated in FIG. 29 and FIG. 36. A vacuum pump 6B sucks the air from the termination vessel 10B through the suction inlet port 11 conveying the TES material and air from the silo. The TES material is dropped in the vessel 10B and the air is pumped from the exhaust of the vacuum pump 6B to the receiver 7 along with the TES material for heating. Once the exhaust vacuum pump 17B sucks air from the receiver 7 the TES enters the vessel 16 and flows back to the silo 2.

In yet another embodiment, the Receiver 7 is essentially a heat exchanger and is designed on the principles of eddy flow or non-laminar flow for maximizing the heat transfer. The primary feature of the Receiver 7 is that the hotspots 77 are generated along the periphery of the cross-sectional area of a receiver 7 placed horizontal to the surface of the earth and in the North-South direction. The Receiver 7 may be further categorized as a) Single Pass Receiver (SPR) and b) Multi Pass Receiver (MPR). The SPR is an assembly of an outer tube and an inner tube. The exit end of the inner tube is closed and for the passing of Thermal Storage Material through the inner tube, the inner tube has specific holes on the periphery and along the length. For a FLT 12 with spot lenses, holes are drilled at the pitch P i.e. the Pitch at which the Hotspots 77 are generated by the corresponding FLT12 module. For a FLT 12 with linear lens the holes are drilled equidistant all along the periphery. Referring FIG. 36B, an internal view of receiver and secondary such pipes are illustrated. Secondary Suction pipes 70 are fixed in the holes as illustrated in FIG. 36A and FIG. 36B in the upper half of the receiver 7. The Secondary Suction Pipes 70 enable the suction of TES material from the inner tube to the outer tube even when the TES material levels in the inner tube are at partially filled. The outer tube contains the inner tube on which the FLT 12 will focus. As illustrated in FIG. 36A, the TES material will enter the receiver 7 from the inner tube from the open end and will be sprayed directly on to the inside surface of the outer tube coinciding beneath the hotspots 77 generated by the FLT 12 through the holes on the lower half of the inner tube and the TES material will be sucked out through the Secondary Suction Pipes 70 present in the upper half of the inner tube. Effectively the TES material is heated and transferred to the exhaust pipe 15 between the outer surface of the inner tube and the inner surface of the outer tube. Depending on the operating Temperature required and Thermal Storage Material used, the Receiver 7 may be made of high grade Stainless Steel, Ceramic Coated Stainless Steel, Ceramic Tubes, High Temperature Quartz glass and the like. A ceramic coated metal receiver 7 may be used for comparatively low temperature TES. A Quartz or Ceramic tube can be used for high temperature TES. The advantage of using a Quartz tube is that the TES material can be directly heated by conduction and enabling faster hear transfer rates by concentrating the solar irradiance directly on the material flowing in the Quartz tube.

In yet another embodiment, a MPR as illustrated in FIG. 36C may be an array of “N” tubes where “N” is equal to the number of sides of the corresponding FLT 12, connected in series and placed concentric to the FLT 12 and the mean diameter of the MPR is placed at half of the allowance given for the radial movement of the FLT 12 so that the outer circumference of the MPR, which has ebbs and crusts may be focused by the movement of the FLT 12. In such MPR the powered FLT 12 may maximize the DNI concentration by continuously focusing on wavy periphery of the MPR. The other advantage of the MPR is that the effective length of the receiver 7 becomes “N” times the length of the FLT 12 i.e. a 10 M. long FLT 12 having 13 sides, will have the receiver 7 length of 130 M., thus making the receiver 7 suitable for heating TES material to higher temperatures. The MPR can be made of high grade Stainless Steel, Ceramic Coated Stainless Steel, Ceramic Tubes and the like.

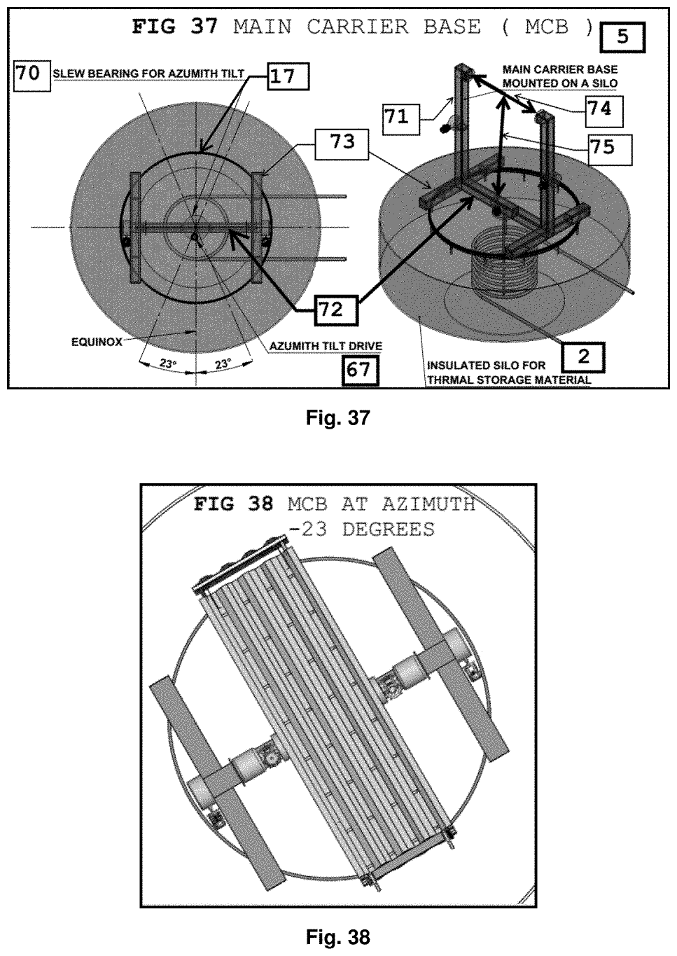

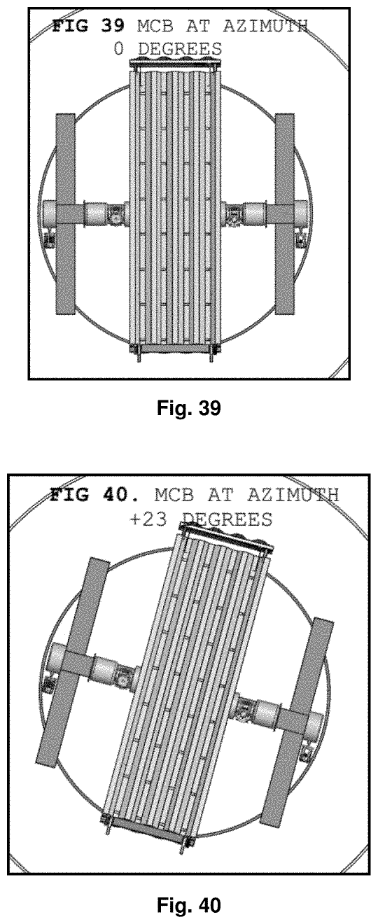

In yet another embodiment, the Main Carrier Base (MCB) 5 is illustrated in FIG. 4, FIG. 5 AND FIG. 37 as a primary load bearing Cartesian mechanical device and an arrangement. The MCB 5 has a large floating Hollow base beam connected with hollow vertical columns 71 with a height 75 so as to admit the RLMS 14 connected with ELFR 13 and as illustrated in FIG. 4, FIG. 5 and FIG. 37 and a width 74 between the columns so as to admit the RLMS 14 connected with the ELFR 13 and the RLMS 14 rotating mechanism as shown FIG. 4, FIG. 5 and FIG. 37 and is capable of sustaining the designed wind loads, the static and dynamic loads of present Industrial and components as described in FIG. 4 and FIG. 5 and FIG. 37, held securely through the Center of Mass of the FLT 12 CSP, with provisions for the desired degree of freedom, on top of an insulated silo 2 by means of a suitable arrangement. A suitable arrangement for the same can be a slewing ring 3, large bearing or any other means, affixed to the center of the horizontal base beam connecting the hollow vertical columns 71 which are structurally supported by a suitable arrangement like, a pair of horizontal stabilizer beams 73 or any other means at the bottom of the vertical columns of the MCB 5 and holding on to a suitable arrangement like a circular guide rail 18 with up-stop and side friction wheels as in FIG. 37 or any other means, coupled with a device or a suitable mechanism, to give a rotary motion to the MCB 5, with a minimum of +/−23⁰ about the Solar Equinox, as illustrated in FIG. 38, FIG. 39 and FIG. 40, around an axis normal to the surface of the earth for providing the required Azimuth tracking 67 to the FLT 12 CSP. A suitable arrangement for this Azimuth Tracking 67 may be a Slewing ring 3 with a ring gear grouted on top of the silo and engaged with a pinion coupled to a compatible gearbox 8 with motor mounted on the base of the MCB 5 as illustrated in FIG. 4, FIG. 5, FIG. 35 and FIG. 37.

In an embodiment, the insulated inlet pipes 9 and exhaust pipes 15 pass through the Center of Mass so as to have a zero-relative movement, thereby eliminating the use of any sort of flexible piping and enabling the use of the FLT 12CSP for high temperature storage material like fine sand, alumina, fly-ash and the like.

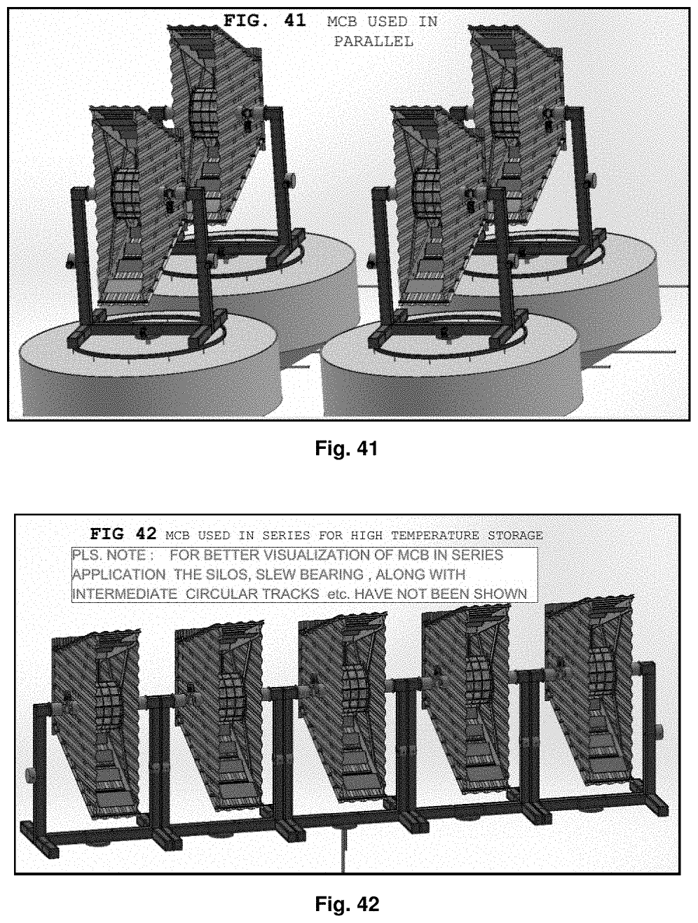

In an implementation, the MCB 5 may be implemented in a Parallel Setup or in a Series Setup as illustrated in FIG. 41 and FIG. 42 respectively. For relatively low temperature thermal storage material the parallel setup is preferred. For comparatively high temperature thermal storage material like sand, Alumina, fly ash the Series Setup with necessary by-pass valves and piping is preferred.

In an implementation, the basic principle of the working of the FLT 12 CSP is as following. The Lens Array receiving normal Incoming Solar Irradiance directly may concentrate the Irradiance on to the suitable receiver 7 and produces the desired hotspots 77. The ELFR 13 reflects incoming irradiance, normal to the other respective Lens Arrays and powers the FLT 12 and the desired hotspots 77 are generated on the receiver 7. The hotspots 77 on the receiver 7 are generated by the principles of conductive heating. The TES material to be used and the TES temperature to be stored in the CSP decides the re-circulating mechanisms and the type of receiver 7 to be used. FIG. 4 illustrates the re-circulating circuitry when using fluids. In such case, the TES material flows as per the Principles of Hydraulics. The inlet pump 6A sucks the TES fluid from the insulated silo 2 and flows through the hot receiver 7 wherein the TES fluid is heated. The Pressure and flow control valves may maintain the desired flow rates and pressure. The exhaust pump 17A may complete the circuit by pumping the hot TES fluid from the receiver 7 to the insulated silo 2. FIG. 5 illustrates the re-circulating circuitry when using particles. In such case, the TES material may flow as per the Principles of Pneumatics (differential pressure). The vacuum pump 6B may suck the air out of the termination vessel 10B on the inlet side and the TES particles are sucked in to the vessel from the insulated silo 2. The Vacuum pump 6B on the exhaust side may suck the air from the termination vessel 10B on the exit side and the TES particles flow from the termination vessel 10B on the inlet side through the hot receiver 7, thereby, getting heated and flow on to the termination vessel 16 on the exit side and the circuit may be completed by pumping the hot exhaust from the Termination vessel 16 from the exhaust side into the exhaust pipe 15 so that the hot TES material is deposited back in the insulated silo 2 for further utilization.

Although implementations for the improved concentrated solar power apparatus enabled by Fresnel lens tunnel is described has been described in language specific to structural features and/or methods, it is to be understood that the appended claims are not necessarily limited to the specific features or methods described. Rather, the specific features and methods are disclosed as examples of implementations for the improved concentrated solar power apparatus enabled by Fresnel lens tunnel.

1. A Concentrated Solar Power (CSP) apparatus to capture Direct Normal Irradiance (DNI) in form of thermal energy and to store the thermal energy in the form of a heat, in a Thermal Energy Storage (TES) material wherein the TES material is used as a heat source characterized in that, the apparatus comprising:
at least one Fresnel Lens Tunnel (FLT 12) having a diameter and a length, the FLT enabled to concentrate DNI in form of hotspots 77 on an inscribing receiver 7;
the receiver 7 containing a re-circulating TES material and having a radius, and a length, comprising an inlet port, a tubular body provided for the heating surface and an exit port, wherein the inlet port is fixed to an inlet manifold 9 and the exit port is fixed to an exit manifold and the receiver 7 is placed horizontal to the surface of the earth in the North-South direction enabling the hotspots 77 to be generated along the length and the periphery of the cross-sectional area of the receiver 7, enabling the TES material to be heated in the tubular body, and wherein the receiver 7 is one of a single pass tubular body or a multi pass tubular body;
the FLT 12 comprising, at least three non-imaging concentrating optical elements 30, each having a height h, a width w and a focal length f, placed with the height h tangential to the circle encompassing the FLT 12 diameter to form a FLT 12 having N sides, wherein N is equivalent to a plurality of the number of non-imaging optical elements 30 placed with height h tangential to the circle encompassing the FLT 12 diameter, held with a desired degree of freedom enabled for in and out radial movement, moving each side of the FLT 12 parallel to the length of the receiver 7 and held to vary the radial distance of the hotspot 77 generated, provided on a mounting structural member of a rotatable device, wherein the radius of the FLT 12 is equal to the sum of the radii of the receiver 7, the focal length of the non-imaging concentrator element and an allowance, wherein the allowance is equal to the enabled in and out radial movement of the sides of the FLT 12 and the FLT 12 length is equivalent to the sum of one or more width w of the non-imaging optical elements 30 placed along the length of FLT 12, and the FLT 12 having the capability of being rotated concentric around the inscribing receiver 7 by the rotatable device;
at least one Enveloped Linear Fresnel Reflector (ELFR 13) to power each side of the FLT 12 which is not receiving DNI, wherein one reflector 44 is enabled to power each of the side of the FLT 12 not receiving DNI, wherein each reflector 44 has the length of the FLT 12, fixed in position to a fixing structural member of the rotatable device such that the incoming solar rays are reflected off the respective reflectors 44 in a direction towards and normal to the respective sides of the FLT 12 and capable of being rotated so as to rotate along with the rotatable device in unison along with the FLT 12;
at least one Reflector and Lens Mount with Shield (RLMS 14) wherein the RLMS 14 is provided with rotary motion by the rotatable device, the RLMS 14 comprising a pair of central hubs 56 for connecting the RLMS 14 to the rotatable device, the RLMS comprising the mounting structural member for mounting the FLT 12 and the RLMS comprising fixing structural member for fixing the ELFR 13 and capable of being rotated in unison along with the FLT 12 and ELFR 13, concentric around the receiver 7 and provide for Elevation Tracking so as to maintain the hotspots 77 generated on the receiver 7;
at least one Main Carrier Base (MCB) 5 for providing azimuth tracking comprising a primary load bearing hollow Cartesian device and apparatus to accommodate and bear the load of the FLT 12, the ELFR 13, the RLMS 14, the receiver 7, and a re-circulating circuit of the TES material from the insulated silo 2 through the receiver 7 and back to the silo further comprising a hollow floating base held securely through the Center of Mass, with a desired degree of rotational freedom, about an axis normal to the surface of the earth and passing through the center of mass of the MCB 5 and connected with hollow vertical columns 71 with a height 75 so as to admit the RLMS 14 fixed with the ELFR 13, and with a width 74 between the columns, so as to admit the RLMS 14 held with a degree of rotational freedom to the RLMS 14 hub on one side and fixed to the MCB 5 on the other side supported by a pair of horizontal stabilizer beams, fixed to hollow base and holding on to a circular guide rail 18 fixed on top of an Insulated silo 2, containing the re-circulating TES material, coupled with a rotating device to give a rotary motion to the MCB 5, with a minimum of +/−23⁰ about the Solar Equinox, around an axis normal to the surface of the earth for providing the required Azimuth tracking 67 to the FLT 12 CSP.

2. The Concentrated Solar Power (CSP) apparatus as claimed in claim 1 wherein a Modified Fresnel Lens Tunnel (MFLT 12″) is formed by replacing two or more adjacent non-imaging concentrator optical elements placed tangential to the circle encompassing the FLT 12 diameter to form a FLT 12, with a single non-imaging concentrating optical element 30 so as to be accommodated between the space of the replaced non-imaging concentrator optical elements 30, having a focal length so as to generate a hotspot 77 on the inscribed receiver 7.

3. The Concentrated Solar Power (CSP) apparatus as claimed in claim 1 wherein the FLT 12 is also produced with a fixed focal length and is called a Fixed Fresnel Lens Tunnel (FFLT 12′) as a tunnel shaped apparatus that is produced as a whole or is produced in parts and assembled or pasted together, as an assembly, and having a minimum of 3 sides wherein each side is capable of mimicking a non-imaging optical element 30, capable of condensing incoming solar irradiance to a focal point and hotspot profile on the receiver 7.

4. The Concentrated Solar Power (CSP) apparatus as claimed in claim 1 wherein the reflectors 44 fixed in the ELFR 13 reflect DNI normal to a three dimensional rotating identity, the identity being the respective sides of the FLT 12, wherein the ELFR 13, designed for a specific FLT 12 consists of a fixed number of reflectors 44 wherein the position of each reflector 44 is derived as a fixed three dimensional theoretical position and the size of each of the reflectors 44 is derived as a fixed maximum theoretical size that can be accommodated in a ELFR 13 without producing a shadow on adjacent reflectors 44, wherein the derived three dimensional fixed position and the derived maximum theoretical fixed size of a reflector 44 are altered to shift position away from the respective side of the FLT 12 and enlarge the fixed size, to accommodate and provide for manufacturing tolerances, by inducing an offset 46 between the fixed derived three dimensional position of 2 adjacent reflectors 44.

5. The Concentrated Solar Power (CSP) apparatus as claimed in claim 1 wherein the reflector 44 is made in parts and fixed on to a frame by and additional rotating and fixing capability is provided for each Reflector 44 in the ELFR 13 to be rotated and fixed in desired position about its own horizontal axis.

6. The Concentrated Solar Power (CSP) apparatus as claimed in claim 1 wherein a reflector 44 cleaning means comprise in the form of scrubbers engaged on the ELFR 13 and non-imaging concentrating optical elements 30 cleaning means comprise in the form of air jets 33 engaged on the FLT 12.

7. The Concentrated Solar Power (CSP) apparatus as claimed in claim 1 wherein a physical protection for the FLT 12 and ELFR 13 is provided by enclosing the ELFR 13 and RLMS 14 by a protective sheet on five sides and a Glass Dust Shield 66 on the front.

8. The Concentrated Solar Power (CSP) apparatus as claimed in claim 1 wherein MCB 5 is enabled to rotate in 360⁰ degrees and further be parked in the shield position on occurrence of a storm or rain so as to offer minimum wind resistance in shield mode.

9. The Concentrated Solar Power (CSP) apparatus as claimed in claim 1, wherein the heat source is used for thermal energy applications, including, heating of secondary TES material, power generation, heat engines, Vapor Absorption Chillers, Desalination plants, Enhanced oil Recovery, hot air generation and for the applications as a furnace.

10. The Concentrated Solar Power (CSP) apparatus as claimed in claim 1, wherein each Fresnel lens is either a liner type Fresnel lens or a spot type Fresnel lens or a silicon on glass type Fresnel Lens or a combination of a spot Fresnel Lens and Linear Fresnel Lens.

11. The Concentrated Solar Power (CSP) apparatus as claimed in claim 1, wherein the single pass receiver 7 is an assembly of an outer tube and an inner tube, and wherein exit end of the inner tube is closed and it has specific holes on the periphery with secondary suction pipes 1 provided on the holes in the upper half and along the length for the passing of Thermal Storage Material.

12. The Concentrated Solar Power (CSP) apparatus as claimed in claim 1, wherein the multi pass receiver 7 is an array of plurality of tubes wherein the number of tubes “N” is equal to the number of sides of the corresponding FLT 12, connected in series and placed concentric to the FLT 12 and the mean diameter of the multi pass receiver 7 is at half of the allowance given for the radial movement of the FLT 12 so that the outer circumference of the multi pass receiver 7 having which has ebbs and crusts can be focused by the movement of the FLT 12 and wherein the FLT 12 is enabled to maximize the DNI concentration by continuously focusing on wavy periphery of the multi pass receiver 7.

13. The Concentrated Solar Power (CSP) apparatus as claimed in claim 1, wherein an insulated inlet pipes 9 and exhaust pipes 15 are passed through the Center of Mass so as to have a zero-relative movement.

14. The Concentrated Solar Power (CSP) apparatus as claimed in claim 1, wherein the MCB 5 is either used in a Parallel Setup or in a Series Setup.
